(19) United States
(12) Patent Application Publication
(10) Pub. No.: US 2007/0215696 A1
(43) Pub. Date: Sep. 20, 2007

(54) ELECTRONIC VOUCHER SYSTEM AND ASSOCIATED METHOD

(76) Inventor: Stephen Cooper Macnish, Bunbury (AU)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/568,138

(22) PCT Filed: Apr. 27, 2005
(86) PCT No.: PCT/AU05/00596

§ 371 Date: Oct. 20, 2006

(30) Foreign Application Priority Data
Apr. 27, 2004 (AU) 2004902191

(51) Int. Cl. G06Q 90/00

(52) U.S. Cl. 235/380

(57) ABSTRACT

An electronic voucher system comprising: a voucher facilitator; at least one merchant; and at least one customer, where each merchant communicates details of themselves and at least one voucher to the voucher facilitator; the voucher facilitator allocates a unique identifier to the merchant and stores details of the at least one voucher and the merchant's allocated unique identifier in a voucher database and prepares an advertisement for publication in a media, the advertisement including a destination address and details of each merchant offering at least one voucher, including their unique identifier; where, when a customer sends a first communication message to the destination address and the voucher facilitator is operable to determine a unique identifier included in, or associated with, the first communication message, the voucher facilitator searches the voucher database for a voucher having a corresponding unique identifier and, when found, sends a second communication message including the voucher to the customer.

### FIELD OF THE INVENTION

The present invention relates to an electronic voucher system and associated method. The invention is particularly suited for providing electronic vouchers via a mobile phone network.

### BACKGROUND ART

The following discussion of the background of the invention is intended to facilitate an understanding of the invention. However, it should be appreciated that the discussion is not an acknowledgment or admission that any of the material referred to was published, known or part of the common general knowledge of the person skilled in the art in any jurisdiction as at the priority date of the application.

One technique available to merchants to improve business is to issue vouchers or coupons that can be redeemed at the merchant's premises or authorized agent. However, the method of distributing such vouchers has typically been by means of mail drops or having someone physically distribute the vouchers to passers by.

Recently, a method of distributing vouchers has developed using mobile phone networks. In such an arrangement, a voucher facilitator sends a series of vouchers, in the SMS message format, to a targeted list of mobile phone users, some or all of whom may not have registered their interest in obtaining such messages. Such an arrangement has three key disadvantages:
1. Sending a large number of SMS messages to mobile phone users, only some of whom may be interested in receiving the voucher the subject of the SMS message, results in bandwidth of the mobile phone carrier being used in an unproductive manner;
2. The cost of sending SMS messages is fixed in the arrangement described, while the uptake of the vouchers the subject of the SMS message may vary. This results in the merchant paying for SMS messages that may have no economic advantage to them; and
3. The potential of alienating the mobile phone user from participating in electronic voucher arrangements in general, due to the perception that the system is akin to spam.

Accordingly, it is an object of the present invention to provide a system whereby customers may electronically request vouchers of their own selection at their convenience. The system of the present invention may provide other ancillary benefits, such as:
allowing a customer to obtain an electronic voucher for a merchant, while the customer is physically present in the merchant's premises; and
merchants who independently would not be able to advertise using mainstream media may use the system as a means of being advertised in such media as part of a collective of merchants who offer vouchers.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the present invention there is an electronic voucher system. The electronic voucher system centers around a voucher facilitator engaged by at least one merchant to provide as agreed voucher services. Each merchant engaged by the voucher facilitator to provide voucher services is allocated a reference code by the voucher facilitator. The voucher facilitator then prepares and places an advertisement including the names of merchants and their reference codes in a media, such as a television guide. Customers may thereafter send a communication message, including a reference code of a merchant published in the advertisement, to a destination address also referred to in the advertisement. In response, the voucher facilitator references the electronic voucher associated with the merchant linked to the reference code the subject of the communication message, and sends the electronic voucher to the customer.

The customer may specify in the communication message whether the electronic voucher is to be sent to a specific customer destination address. If not, the voucher facilitator will operate to obtain the customer destination address to send the voucher to by known techniques such as caller identification.

In agreeing on the services to be provided between merchant and voucher facilitator, the voucher facilitator may request the merchant to specify details relating to at least one of the following:
a dynamic expiry date or fixed expiry date for all electronic vouchers issued;
the specific medium or media that the merchant wishes to advertise through; and/or
the price of the electronic voucher.

The voucher facilitator may assess any proposed voucher before approving its use in the electronic voucher system. The assessment of the proposed voucher may look at such factors as expected validity period following publication of the advertisement and economic value.

As customers may send communication messages containing a reference code that has expired or is in error, the voucher facilitator may operate to provide an error message back to such customers along with a default electronic voucher. The default electronic voucher may be taken at random or in sequence from the range of electronic vouchers provided by the voucher facilitator. Alternatively, the voucher facilitator may offer the default electronic voucher position as a premium service.

Merchants may also be able to specify multiple electronic vouchers to be dispensed by the voucher facilitator, each bar one having limitations imposed thereon regarding dispensation of the voucher. The electronic voucher not having a limitation imposed therein is set as a default voucher. In this manner, if the limitations regarding the other vouchers are exceeded, the customer is still provided with the default voucher on request. The type of limitations able to be imposed on the electronic vouchers are numerous.

Alternatively, the voucher facilitator may simply allow for a merchant to modify the electronic voucher as desired.

The electronic voucher may include a reference identifier, such as a barcode, and a request to “opt-in” for additional marketing/promotional services. If a barcode or similar reference identifier is provided, the electronic voucher may be scanned by the merchant at the point of redemption to obtain a record of the voucher having been used and to facilitate automatic redemption of the voucher by electronic means (if implemented). Alternatively, the barcode, or another reference identifier, can be used by a representative of the merchant in their manual or semi-manual redemption procedure.

A record of all transactions may be kept by the voucher facilitator to assist in their own reconciliation activities and those of its merchants.

Ideally, the electronic voucher system is directed towards implementation within a communications network, such as a mobile phone network. The system can, however, be adapted for use in communication networks such as the internet and interactive television networks. It should be appreciated that in such arrangements, the communication messages used should not be limited to SMS messages and can include e-mail messages, MMS messages or the use of interactive voice recognition systems.

In accordance with a second aspect of the invention there is a voucher facilitator for use in an electronic voucher system as described in the first aspect of the invention. Further, in accordance with a third aspect of the invention there is a method of obtaining an electronic voucher substantially as described in the context of the first aspect of the invention.

### BRIEF DESCRIPTION OF THE DRAWINGS

The invention will now be described, by way of example only, with reference to the accompanying drawings, of which:

FIG. 1 is a schematic representation of a first embodiment of the electronic voucher system.

FIGS. 2A and 2B are illustrations of two types of advertisements that form part of the electronic voucher system.

FIGS. 3A and 3B are flowcharts of a first embodiment of the electronic voucher system.

FIGS. 4A and 4B are flowcharts of a second embodiment of the electronic voucher system.

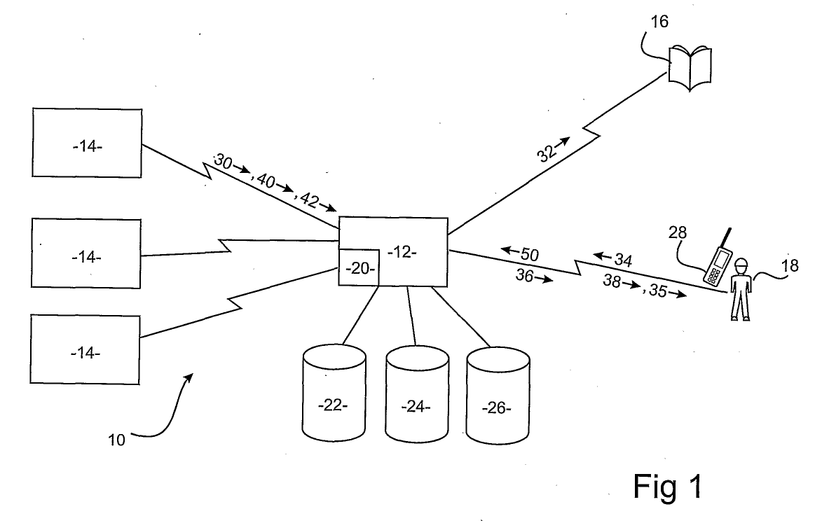

### BEST MODE(S) FOR CARRYING OUT THE INVENTION

In accordance with a first embodiment of the invention, there is an electronic voucher system 10. The electronic voucher system 10 comprises:
a voucher facilitator 12;
at least one merchant 14;
at least one media 16; and
at least one customer 18.

The voucher facilitator 12 comprises a message gateway 20, a voucher database 22, a customer database 24 and an audit database 26.

Each customer 18 possesses a mobile phone 28. The customer 18 and voucher facilitator 12 are operable to communicate with one another via the message gateway 20.

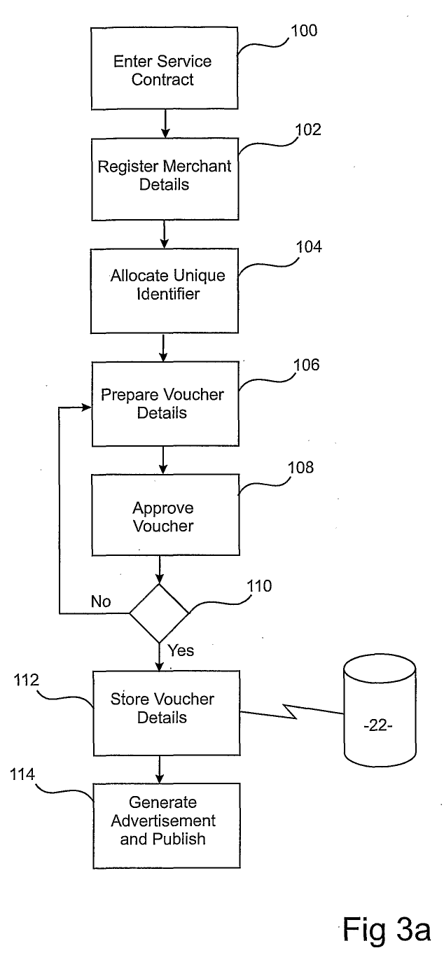

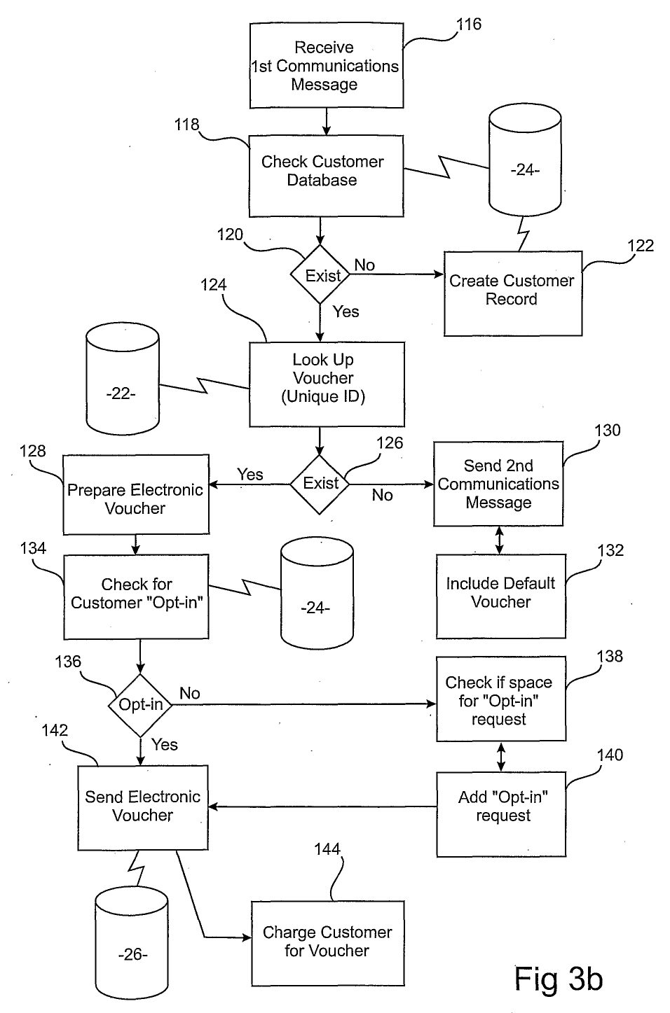

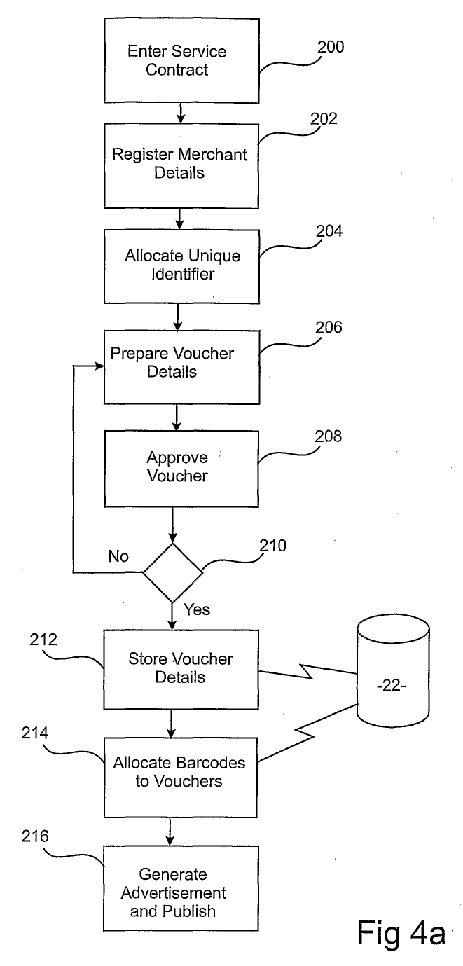

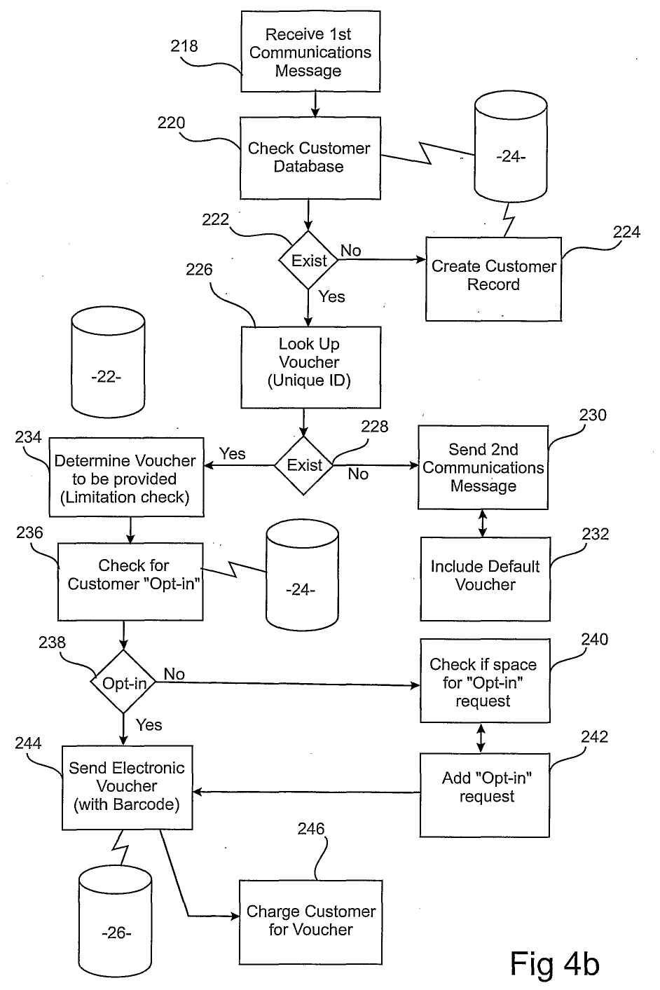

The interaction between the above components of the electronic voucher system 10 will now be described in the context of two examples of the system in use (see FIGS. 3 and 4). Additional features as required to properly illustrate the system are also described hereafter.

In a first example of the electronic voucher system 10, merchant 14 contacts the voucher facilitator 12 to register their interest in participating in the electronic voucher system 10. This is done by the merchant 14 entering into a service contract, at step 100, with the voucher facilitator 12. The voucher facilitator 12 then registers predetermined details pertaining to the merchant, including their trading name, in the voucher database 22 (step 102). As part of the registration process, and as indicated at step 104, the merchant 14 is also allocated a unique identifier (hereafter referred to as a “vcode”). The vcode is subsequently used by the voucher facilitator 12 to facilitate transactions involving the merchant 14 (see below) and is the primary key for records stored in the voucher database 22.

Once registered, the merchant 14 prepares details of the voucher 30 they wish to offer using the electronic voucher system 10 (step 106). These details are then submitted to the voucher facilitator 12 for approval (step 108). If, at step 110, the voucher facilitator 12 approves the proposed voucher 30, processing continues to step 112. Otherwise, the merchant 14 is informed that the proposed voucher 30 is unacceptable and steps 106 through 110 repeat until the merchant 14 submits a proposed voucher 30 the voucher facilitator 12 approves.

While approval criteria may vary from voucher facilitator 12 to voucher facilitator 12, it is important that the voucher facilitator 12 checks each proposed voucher 30 for economic value (i.e. by comparing the cost of the voucher 30 to the potential economic benefit provided by the voucher 30) and to ensure that the duration of the offer will be such that the customer 18 will have adequate time to take advantage of the offer, taking into account the voucher facilitator's advertising schedule (see below).

Details of the voucher 30 approved by the voucher facilitator 12 is then stored in the voucher database 22 and linked to the predetermined details of the merchant 14 previously stored (step 112).

The voucher facilitator 12 thereafter operates to generate an advertisement 32 (step 114). The advertisement 32 is tailored towards the particular media 16 through which it is to be advertised (e.g. printed advert for magazine/newspaper publications, leaflets and websites, voice advert for radio and cinematographic work for television). Included in the advertisement 32 is the trading name and vcode for each merchant 14 stored in the voucher database 22. The advertisement 32 also includes details of the destination address to which a first communication message 34 must be sent in order to obtain an electronic voucher 36 from a published merchant 14 (as identified by their trading name). Each advertisement 32 is only valid for a predetermined period of time.

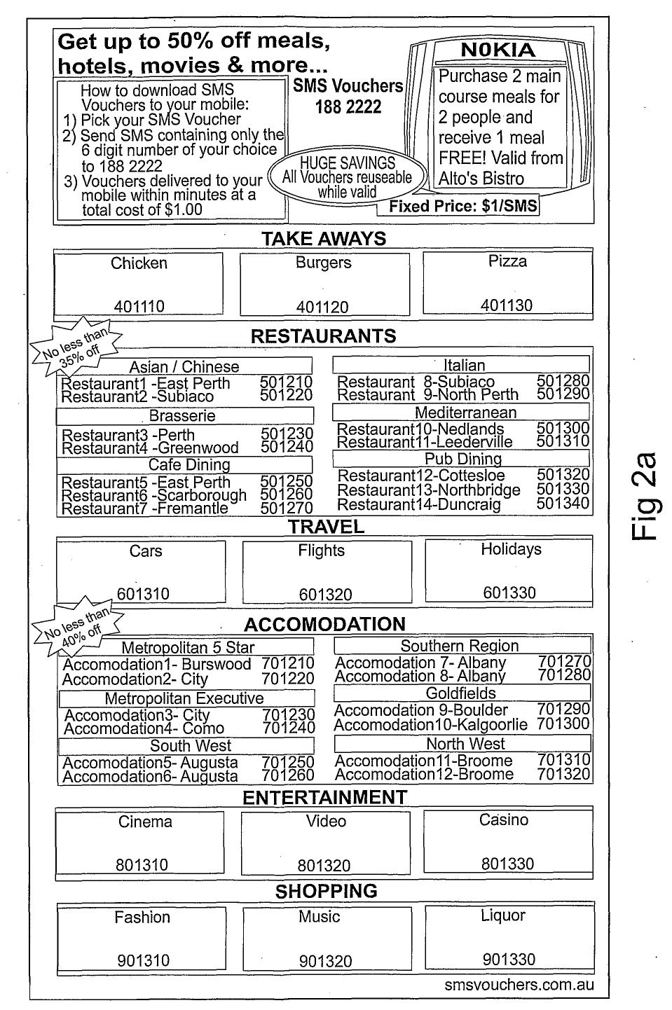

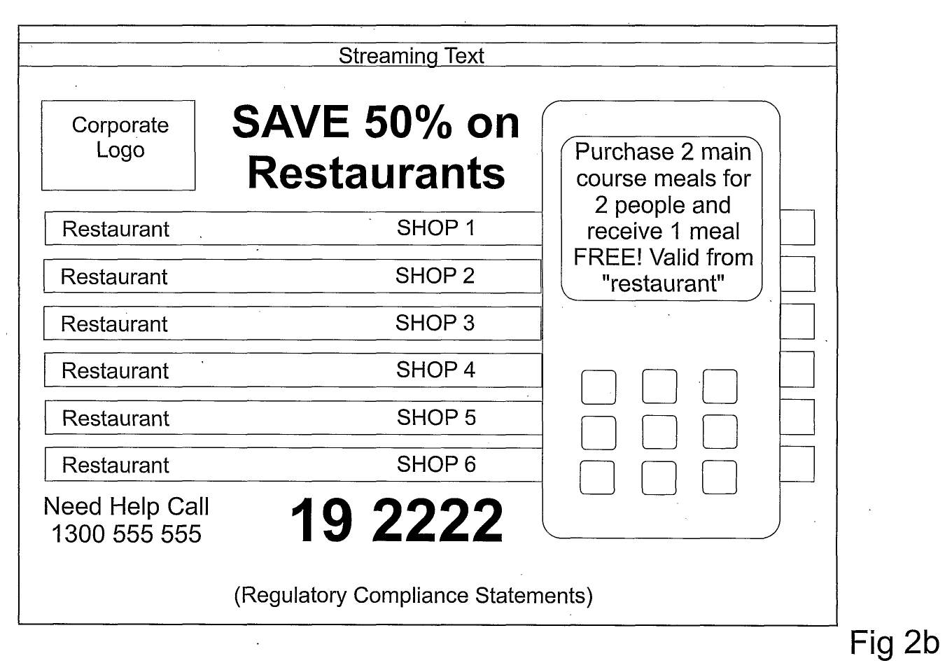

An example of the types of advertisement 32 that can be produced for the purposes of this example are shown at FIGS. 2A and 2B. The first advertisement shown is a print-based advertisement while the second is a television-based advertisement.

A customer 18 who peruses the media 16 through which the advertisement 32 has been advertised may then seek to take advantage of the vouchers offered. To do so, the customer 18 first identifies the published merchant 14 that they wish to obtain an electronic voucher 36 from and that merchant's 14 associated vcode. The customer 18 then sends a first communication message 34, using mobile phone 28, to the destination address (step 116) referred to in the advertisement 32—the first communication message 34 including the merchant's 14 vcode and, optionally, the destination address to which the electronic voucher 36 should be sent.

If the customer 18 does not specify a destination address in the first communication message 34, the voucher facilitator 12 obtains a destination address by other means. Such other means may include the use of caller identification techniques.

Upon receiving the first communication message 34 from the customer 18, the voucher facilitator 22 first checks a customer database 24 (step 118). The customer database 24 includes records containing details of all customers 18 who have previously requested an electronic voucher 36. The primary key of each record in the customer database 24 is the customer's destination address.

If the customer 18 does not have a matching record (as determined at step 120) in the customer database 24, voucher facilitator 12 then operates to create such a record (step 122).

The voucher facilitator 12 then proceeds to process the first communication message 34. This is done by initially looking up the vcode included in the first communication message 34 against the records stored in voucher database 22 (step 124). Upon identifying a matching record (as determined at step 126), the voucher facilitator 12 starts preparing the electronic voucher 36 for sending to the customer 18 (step 128). If a matching record cannot be found, the customer 18 is sent a second communication message 38 requesting the customer 18 check that the vcode sent is correct and that the advertisement 32 from which they obtained the vcode is still valid (step 130).

As the customer 18 is charged for the communication messages 34, 38, to improve customer 18 satisfaction with the electronic voucher system 10, the second communication message 38 may include a default electronic voucher 35 (step 132).

Preparation of the electronic voucher 36 sees the voucher facilitator 12 check the customer's 18 matching record in the customer database 24 to determine whether they have previously opted to receive broadcast alerts and other promotions from the voucher facilitator 12 (i.e. has the customer “opted-in”—step 134). If not (as determined at step 136), a determination is made as to whether the communication message to be used to transmit the electronic voucher 36 has sufficient space to add an invite to the customer 18 to “opt-in” (step 138). If so, a determination is also made as to whether such an invite is to be included in the communication message (step 140). The communication message used to transmit the electronic voucher 36 is then sent to the customer 18 at their designated or identified destination address, as appropriate (step 142).

While all communication messages between voucher facilitator 12 and customer 18 are transmitted via the message gateway 20, the message gateway 20 takes no action until such time as the communication message to be transmitted includes an electronic voucher 36. On receipt of such a communication message, the message gateway 20 operates to record details of the electronic voucher 36 in the audit database 26. At this time, the voucher facilitator 12 also operates to charge the customer 18 for the provision of the electronic voucher 36 in accordance with a pre-determined voucher price as stored in the appropriate record of voucher database 22 (step 144).

The voucher facilitator 12 can use the electronic voucher details recorded in the audit database 26 to undertake auditing and reconciliation activities. It also allows the voucher facilitator 12 to provide details to merchants 14 of electronic vouchers 36 provided to customers 18 to facilitate the merchant's 14 own voucher reconciliation and redemption procedures.

The customer 18 is then free to attend the merchant's premises 14, or the premises of an agent of the merchant 14, and make use of the electronic voucher 36. The merchant's 14 redemption procedures are a matter for the merchant 14, however, the customer 18 is required to show the electronic voucher 36 as part of the redemption procedure.

As indicated above, the electronic voucher 36 may include a message inviting the customer 18 to “opt-in”. If a customer 18 wishes to take up this invitation, the customer 18 replies to the electronic voucher 36 via a third communication message 50. The third communication message 50 must include in the body text some form of acknowledgment that the customer 18 wishes to “opt-in”. In this manner, a reply made in error is not treated as a request to “opt-in”.

On receipt of the third communication message 50, the voucher facilitator 12 parses the third communication message 50 for two pieces of information:
acknowledgment that the customer 18 wishes to “opt-in”; and
the customer's 18 destination address (in this case, the customer's 18 mobile phone number).

On verification of these details, the voucher facilitator 12 conducts a search of the customer database 24 for a matching record. Once found, the record is updated to show that the customer has “opted-in”.

The marketing processes associated with customers 18 who have “opted-in” are various and will not be discussed here.

In accordance with a second, preferred, example of the electronic voucher system 10, merchant 14 contacts the voucher facilitator 12 to register their interest in participating in the electronic voucher system 10. This is done by the merchant 14 entering into a service contract, at step 200, with the voucher facilitator 12. The voucher facilitator 12 then registers predetermined details pertaining to the merchant, including their trading name, in the voucher database 22 (step 202). As part of the registration process, and as indicated at step 204, the merchant 14 is also allocated a vcode. The vcode is subsequently used by the voucher facilitator 12 to facilitate transactions involving the merchant 14 (see below) and is the primary key for records stored in the voucher database 22.

Once registered, the merchant 14 prepares details of a limited run voucher 40 and default voucher 42 they wish to offer using the electronic voucher system 10 (step 206). Details of the limited run voucher 40 must include the limitations to be imposed upon issuing of the voucher. Such limitations may include issuing of the limited run voucher 40 only during a stated time period, or issuing of only a limited number of limited run vouchers 40.

The details of the proposed limited run voucher 40 and default voucher 42 are then submitted to the voucher facilitator 12 for approval (step 208). If, at step 210, the voucher facilitator 12 approves the proposed vouchers 40, 42, processing continues to step 212. Otherwise, the merchant 14 is informed that the proposed vouchers 40, 42 are unacceptable and steps 206 through 210 repeat until the merchant 14 proposes vouchers 40, 42 the voucher facilitator 12 approves. To facilitate matters at the merchant's 14 end, the voucher facilitator 12 may inform the merchant 14 as to the nature of its objections to the proposed vouchers 40, 42.

Details of the vouchers 40, 42 approved by the voucher facilitator 12 are then stored in the voucher database 22 and linked to the predetermined details of the merchant 14 previously stored (step 212). This includes recording details of the limitations to be imposed on the limited run voucher 40.

In addition to storing details of the vouchers 40, 42 approved by the voucher facilitator 12, a barcode 44 for each voucher 40, 42 is stored in voucher database 22 (step 214). Each barcode 44 is linked to the stored details of the voucher 40, 42 to which it relates.

The voucher facilitator 12 thereafter operates to generate an advertisement 32 (step 216). The advertisement 32 is tailored towards the particular media 16 through which it is to be advertised (e.g. printed advert for magazine/newspaper publications, voice advert for radio and cinematographic work for television). Included in the advertisement 32 is the trading name and vcode for each merchant 14 stored in the voucher database 22. The advertisement 32 also includes details of the destination address to which a first communication message 34 must be sent in order to obtain an electronic voucher 36 from a published merchant 14 (as identified by their trading name). Each advertisement 32 is only valid for a predetermined period of time.

An example of the type of advertisement 32 that is produced for the purposes of this example is shown at FIG. 2.

A customer 18 who peruses the media 16 through which the advertisement 32 has been advertised may then seek to take advantage of the vouchers offered. To do so, the customer 18 first identifies the published merchant 14 that they wish to obtain an electronic voucher 36 from and that merchant's 14 associated vcode. The customer 18 then sends a first communication message 34, using mobile phone 28, to the destination address (step 218) referred to in the advertisement 32—the first communication message 34 including the merchant's 14 vcode and, optionally, the destination address to which the electronic voucher 36 should be sent.

If the customer 18 does not specify a destination address in the first communication message 34, the voucher facilitator 12 obtains a destination address by other means. Such other means may include the use of caller identification techniques.

Upon receiving the first communication message 34 from the customer 18, the voucher facilitator 22 first checks a customer database 24 (step 220). The customer database 24 includes records containing details of all customers 18 who have previously requested an electronic voucher 36. The primary key of each record in the customer database 24 is the customer's destination address.

If the customer 18 does not have a matching record in the customer database 24 (as determined at step 222), voucher facilitator 12 then operates to create such a record (step 224).

The voucher facilitator 12 then proceeds to process the first communication message 34. This is done by initially looking up the vcode included in the first communication message 34 against the records stored in voucher database 24 (step 226). Upon identifying a matching record (as determined at step 228), the voucher facilitator 12 starts preparing the electronic voucher 36 for sending to the customer 18 (step 234). If a matching record cannot be found, the customer 18 is sent a second communication message 38 requesting the customer 18 check that the vcode sent is correct and that the advertisement 32 from which they obtained the vcode is still valid (step 230). The electronic voucher 36 may also include a default voucher as described above (step 232).

Preparation of the electronic voucher 36 sees the voucher facilitator 12 first determine which voucher 40, 42 is to be provided (step 234). This is done by assessing whether the limitations placed on the limited run voucher 40 have been exceeded.

Due to the various limitations that may be placed on a limited run voucher 40, the mechanisms by which an assessment of whether the limitations placed on the limited run voucher 40 have been exceeded will not be described in depth as such would be known to the person skilled in the art. However, as examples, an assessment of whether a date limitation has exceeded can be done through a simple comparison to the then current date and an assessment of whether the number of limited run vouchers 40 able to be issued has been exceeded can be achieved through a simple counter operation.

Once the appropriate voucher has been determined, the voucher facilitator 12 checks the customer's 18 matching record in the customer database 24 to determine whether they have previously “opted-in” (step 236). If not (as determined at step 238), a determination is made as to whether the communication message to be used to transmit the electronic voucher 36 has sufficient space to add an invite to the customer 18 to “opt-in” (step 240). If so, a determination is also made as to whether such an invite is to be included in the communication message (step 242). Accordingly, in this example, the electronic voucher 36 will contain the following information:
Details of the merchant offering the voucher;
Details of the offer the subject of the voucher, ie details of either the limited run voucher 40, or the default voucher 42;
the barcode 44 linked to the offer the subject of the voucher; and
Optionally, an invite to the customer 18 to “opt-in”

The communication message used to transmit the electronic voucher 36 is then sent to the customer 18 at their designated or identified destination address, as appropriate (step 244).

While all communication messages between voucher facilitator 12 and customer 18 are transmitted via the message gateway 20, the message gateway 20 takes no action until such time as the communication message to be transmitted includes an electronic voucher 36. On receipt of such a communication message, the message gateway 20 operates to record details of the electronic voucher 36 in the audit database 26. At this time, the voucher facilitator 12 also operates to charge the customer 18 for the provision of the electronic voucher 36 in accordance with a pre-determined voucher price as stored in the appropriate record of voucher database 22 (step 246).

The customer 18 is then free to attend the merchant's premises 14, or the premises of an agent of the merchant 14, and make use of the electronic voucher 36.

Redemption of the electronic voucher 36 requires the customer to present their mobile phone 28 to a representative of merchant 14—the mobile phone 28 clearly displaying the communication message containing the electronic voucher 36. The representative of merchant 14 then scans the barcode 44 included in the electronic voucher 36 to obtain, electronically, details of the electronic voucher 36. By allowing for scanning of an electronic voucher 36, the process of validating the electronic voucher 36 can be automated by the merchant 14.

To elaborate, the merchant 14 may implement electronic processes as would be known to the person skilled in the art to ensure:
that the person seeking to redeem the electronic voucher 36 is the customer 18 who initially received the electronic voucher 36;
that the electronic voucher 36 to be redeemed is a voucher that has been submitted to the voucher facilitator 12 by the merchant 14;
that the electronic voucher 36 to be redeemed remains valid; and
that the redemption of the electronic voucher 36 complies with any limitations set that relate to redemption.

If the electronic processes implemented by the merchant 14 verify that the electronic voucher 36 is good, the representative of merchant 14 can then take the appropriate steps to redeem the electronic voucher 36. Further, the use of electronic processes in redeeming an electronic voucher 36 allows the merchant 14 to operate a reconciliation process in conjunction with the voucher facilitator 12. This then allows the merchant 14 to identify the level of uptake of the electronic vouchers 36 issued by the voucher facilitator 12. Additionally, this may allow the merchant 14 to implement procedures to ensure that an electronic voucher 36 has not been used more than once (or in situations where the electronic voucher 36 is able to be used more than once, has not been used beyond its maximum).

It should be appreciated by the person skilled in the art that the invention is not limited to the examples described. In particular, the following additions and/or modifications can be made without departing from the scope of the invention:
The system 10 may be adapted to allow merchants to provide bundled vouchers. A bundled voucher would be sent in the one communication message but would cover offers provided by multiple merchants 14. Bundled vouchers may be advertised separately (with a separate destination address being used for requesting bundled vouchers) or advertised along with vouchers offered by single merchants 14.
The communication message may be transmitted by means of e-mail, MMS message, interactive television communications or facilitated through the use of an interactive voice recognition system. The communications messages may also be transmitted by means of any type of broadband messaging for mobile phones, instant messaging, or through the communication protocols established for Internet access.
The service contract between voucher facilitator 12 and merchant 14 may include specifics as to the types of medium 16 that the merchant 14 wishes to advertise through. Alternatively, the service contract may be for a limited period of time. In yet a further alternative, the service contract may specify the “level” of exposure to be included in the advertisement 32. For example, exposure may be split into “lineage” advertisements—such as those specified under the Restaurants and Accommodation sections in the example advertisement of FIG. 2—or “graphic” advertisements—such as those specified under the Take Aways, Travel, Entertainment and Shopping” sections in the example advertisement of FIG. 2.
In any of the aforementioned arrangements, compilation of the advertisement 32 will need to be made with reference to the criteria set out in the merchant's 14 service contract.
The voucher database 22 can be modified to retain details of merchant's 14 whose service contract has been expired, suspended or terminated. While vouchers for such merchants 14 would not be included in any current advertisement 32, retaining such details could be used by the voucher facilitator 12 to determine an appropriate error message to send to a customer 18 who requests a voucher from such a merchant 14.
In yet another arrangement of the invention, the voucher facilitator 12 may request each merchant 14 to specify an expiry period for their voucher 30 as part of the approval process. Accordingly, when preparing the electronic voucher 38, the voucher facilitator 12 dynamically calculates an expiry date for the electronic voucher 38 and includes the calculated expiry date in the finalized electronic voucher 38.
The barcode 44 may be replaced with another unique identifier. The unique identifier may be adapted to be read electronically at the merchant's 14 point of sale. Alternatively, the unique identifier may be such that an employee of the merchant 14, or an employee of a representative of the merchant 14, may be able to enter the unique identifier into an electronic data processing system—the electronic data processing system thereafter operable to conduct at least one of the validation checks mentioned in the second example.
The electronic voucher system 10 could be used by shopping centers, or the like, as an in-house promotion tool. In such an arrangement, rather than advertising in a mainstream media 16, the shopping center or other entity can produce their own media 16, such as a leaflet or noticeboard, detailing participating merchants 14 and their respective vcodes. In all other respects, however, the electronic voucher system 10 would operate as described above.
The vcode may take a variety of formats, including numeric, alphabetic or alphanumeric.
The electronic voucher system 10 may be adapted to handle more than the two voucher per merchant 14 arrangement described in the second example. In such an arrangement, there would need to be some means of determining which voucher is the appropriate one to send to a customer 18 on receipt of a communication message specifying the merchant 14.
Provision can be made for the merchant 14 to modify the voucher presently being provided by the voucher facilitator 12. Any modified voucher would need to be resubmitted to the voucher facilitator 12 for approval, prior to formal implementation within the electronic voucher system 10. In this manner merchants 14 can continuously update the vouchers 30 being provided to customers without needing to change the advertisement 32 in the printed media.
The selection of the default electronic voucher 35 may be chosen from amongst the vouchers 30 of merchants 18 who have entered into service contracts with the voucher facilitator 12. The selection may also be on a random, semi-random or sequential basis. Alternatively, the selection of default electronic voucher 35 may be a premium service offered by the voucher facilitator 12.
In place of barcodes, a system can be used where the merchant 18, or its representative, is in possession of an EFTPOS terminal, or similar device, that can communicate with the voucher facilitator 12. The vouchers 30 designed for operation with this system include a unique identification number. When a customer then presents a voucher 30 to the merchant 18, or its representative, the unique identification number is keyed into the EFTPOS terminal or similar device. The EFTPOS terminal or similar device then connects with the voucher facilitator 12 to obtain details of the voucher and, optionally, to mark the voucher as redeemed. Note that it is not required for the terminal to provide EFTPOS capability in addition to its functions as required by the electronic voucher system 10. For example, smart phones or other data processing apparatus including an embedded browser application may be substituted for the EFTPOS terminal.
In a modification of the system described in the previous paragraph, the unique identification number may include a component designed to ensure that the voucher 30 provided to a customer is redeemed only by that customer. For example, the unique identification number may include a numerical value representative of the voucher and a portion of the destination address, or other identifier, to which the voucher was sent. Alternatively, the customer may be asked to set up a personal identifier, such as a PIN or password, when their customer record is established and this personal identifier may be used in place of the portion of the destination address to which the voucher was sent.
In a further modification of the system described in either of the last two paragraphs, the merchant, or their representative, may be requested to enter in an operator identifier and/or store identifier during the redemption process. These identifiers, in addition to information already recorded from the customer while obtaining the voucher allows for greater scope in auditing voucher redemption.
Parts of the invention may be performed manually or automatically as desired.

It should be further appreciated by the person skilled in the art that features and modifications discussed in the examples above, not being alternatives or substitutes, can be combined to form yet other embodiments that fall within the scope of the invention described.

1-59. (canceled)

60. An electronic voucher system comprising:
a voucher facilitator; and
at least one merchant, the merchant communicates details of themselves and at least one voucher to the voucher facilitator;
wherein the voucher facilitator allocates a unique identifier to the merchant and stores details of the at least one voucher and the merchant's allocated unique identifier in a voucher database and prepares an advertisement for publication in or on a media, the advertisement including a destination address, details of each merchant offering at least one voucher, and the merchant's allocated unique identifier;
where, when a customer sends a first communication message to the destination address and the voucher facilitator is operable to determine a unique identifier included in, or associated with, the first communication message, the voucher facilitator searches the voucher database for at least one voucher having a corresponding unique identifier and, when found, sends a second communication message including one of the at least one voucher to the customer.

61. The electronic voucher system according to claim 60, wherein the at least one merchant communicates details of at least one limitation voucher and details of a default voucher, and where, when a customer requests a voucher from the merchant by way of the first communication message, the voucher facilitator checks to see whether limitations set for each limitation voucher have been exceeded and, if the limitations set for a limitation voucher have not been exceeded, operate to send a second communication message including that limitation voucher to the customer, and, if the limitations set for all limitation vouchers have been exceeded, operate to send a second communication message including the default voucher to the customer.

62. The electronic voucher system according to claim 61, wherein the limitations set for a limitation voucher is selected from the group consisting of a limited time period, and a limited quantity.

63. The electronic voucher system according to claim 60, wherein the voucher facilitator only publishes the details of each merchant offering at least one voucher, including their unique identifier, if the voucher facilitator approves the details of the voucher after assessment, and wherein assessment of the voucher includes assessment of at least one of the following criteria selected from the group consisting of economic value, duration of offer, quantity limitation and duration of limitation time period.

64. The electronic voucher system according to claim 60, wherein the voucher facilitator allocates a second unique identifier to each voucher for which it has received details, publishes the second unique identifier as a concatenation of the merchant's allocated unique identifier in the advertisement for each voucher advertised by the merchant in the advertisement such that when the voucher facilitator receives the first communication message the voucher facilitator searches the voucher database for the voucher having the corresponding unique identifier and second unique identifier concatenation and, when found, sends the second communication message including that voucher.

65. The electronic voucher system according to claim 64, wherein the voucher facilitator obtains details of the second destination address to which the electronic voucher should be sent from information contained in the first communication message.

66. The electronic voucher system according to claim 64, wherein the voucher facilitator obtains details of the second destination address to which the electronic voucher should be sent using caller identification techniques.

67. The electronic voucher system according to claim 60, wherein the voucher facilitator allocates a unique electronic identifier to each voucher for which it has received details, such that when the merchant, is presented with the electronic voucher the unique electronic identifier is utilized to obtain details of the electronic voucher.

68. The electronic voucher system according to claim 67, wherein the unique electronic identifier is a numerical value and the merchant obtains details of the electronic voucher by entering the numerical value into a data processing device in communication with the voucher facilitator, the voucher facilitator operable to provide details of the voucher to the merchant on authentication of the numerical value, and wherein, on authenticating the numerical value, the voucher facilitator operates to record the associated voucher as redeemed.

69. The electronic voucher system according to claim 68, wherein the numerical value includes a personal identifier operable to identify the customer who received the second communication message including the voucher being redeemed, and wherein the merchant enters in further details allowing the voucher facilitator to identify the representative of the merchant processing the voucher and/or the store where the voucher is being processed.

70. The electronic voucher system according to claim 60, wherein the merchant processes the voucher to determine at least one of the following selected from the group consisting of its validity, whether the voucher has been redeemed previously, whether the person who received the voucher is the person seeking to redeem the voucher, and whether the redemption of the voucher complies with any limitations set on the voucher.

71. The electronic voucher system according to claim 60, wherein if a record cannot be found in the voucher database having a corresponding unique identifier, a third communication message is sent to the at least one customer requesting them to confirm the unique identifier and/or the validity of the published advert, and wherein the third communication message includes a default electronic voucher, the default electronic voucher being selected on a random, semi-random, or sequential basis.

72. The electronic voucher system according to claim 71, wherein the second communication message includes a query as to whether the customer wishes to receive alerts and promotions and, if so, the customer sends a fourth communication message in reply to the second communication message and, if the fourth communication message includes a predetermined positive response to the query, the voucher facilitator operates to establish a customer's corresponding record in a customer database, indexed by the second destination address, to indicate that they wish to receive such alerts and promotions.

73. A method of providing an electronic voucher to a customer comprising the steps of:
receiving details of at least one merchant and allocating a unique identifier to the merchant;
receiving details of at least one voucher to be provided by the at least one merchant;
storing details of the at least one voucher and the merchant's allocated unique identifier in a voucher database;
preparing an advertisement for publication in or on a media, the advertisement including a destination address and details of each merchant offering at least one voucher, including their unique identifier;
receiving a first communication message at the destination address;
determining a unique identifier included in, or associate with, the first communication message; and
searching the voucher database for a voucher having a corresponding unique identifier and, when found, sending a second communication message including one of the at least one voucher to the customer.

74. The method of providing an electronic voucher according to claim 73 further comprising the step of receiving details of at least one voucher to be provided by the at least one merchant includes the substeps of receiving details of at least one limitation voucher and receiving details of a default voucher; the method further including the repeating steps of:
checking to see whether the limitations set for a limitation voucher have been exceeded;
sending a second communication message including the limitation voucher checked if the limitations have not been exceeded;
and including the step of sending a second communication message including the default voucher if the limitations set for all limitation vouchers have been exceeded.

75. The method of providing an electronic voucher according to claim 73 further comprising the step of assessing the details of the at least one voucher and only publishing the details of each merchant offering at least one voucher in the advertisement, including their unique identifier, if the details of the voucher are approved after assessment, and the step of obtaining details of a second destination address to which the second communication message should be sent, using caller identification techniques.

76. The method of providing an electronic voucher according to claim 75, further comprising the steps of: allocating a unique electronic identifier to each voucher for which details have been received; receiving a communication from a data processing device including a numerical value; providing details of the voucher for which the numerical value equals the unique electronic identifier, to a merchant on authentication of the numerical value; and marking the voucher as redeemed.

77. The method of providing an electronic voucher according to claim 76 further comprising the steps of confirming that the customer who received the second communication message is the same customer who is redeeming the voucher by authenticating a personal identifier forming part of the numerical value, and sending a third communication message to the at least one customer requesting them to confirm the unique identifier and/or the validity of the published advert if a record cannot be found in the voucher database having a corresponding unique identifier.

78. The method of providing an electronic voucher according to claim 77 further comprising the steps of: including a default electronic voucher in the third communication message; including a query as to whether the customer wishes to receive alerts and promotions in the second communication message; establishing a customer's corresponding record in a customer database, indexed by the second destination address, indicating that they wish to receive such alerts and promotions on receiving a reply communication message including a predetermined positive response to the query; checking the customer database for a record having a corresponding second destination address as its primary key; including broadcast alerts and other promotions in the second communication message if the customer's record indicates that they wish to receive such alerts and promotions; and recording details of the second communication message in an audit database and using the information stored in the audit database to provide auditing and reconciliation services to merchants.

79. A computer readable medium having software recorded thereon, the software including:
membership means for receiving details of at least one merchant and at least one voucher to be provided by the at least one merchant and allocate a unique identifier to the merchant;
a voucher database for storing details of the at least one voucher and the merchant's allocated unique identifier;
publication means for preparing an advertisement for publication in or on a media, the advertisement including a destination address and details of each merchant offering at least one voucher, including their unique identifier; and
customer interaction means for receiving a first communication message at the destination address; determining a unique identifier included in, or associate with, the first communication message; searching the voucher database for a voucher having a corresponding unique identifier; and, when found, sending a second communication message including the voucher to the customer.
